(19) United States
(12) Patent Application Publication
(10) Pub. No.: US 2012/0098167 A1
(43) Pub. Date: Apr. 26, 2012

(54) METHOD OF TREATING A HOT FILLED PLASTIC THIN WALLED CONTAINER AND ASSOCIATED DEVICE

(75) Inventor: Jean-Tristan Outreman, Saint Maximin La Sainte Baume (FR)

(73) Assignee: TECSOR HR, Meyreuil (FR)

(21) Appl. No.: 13/379,802

(22) PCT Filed: Jul. 29, 2009
(86) PCT No.: PCT/FR2009/051526

§ 371 Date: Dec. 28, 2011

(30) Foreign Application Priority Data
Jul. 29, 2008 (FR) 0855198

(51) Int. Cl. B29C 49/64

(52) U.S. Cl. 264/524; 425/526

(57) ABSTRACT

A process for treatment of a thin-walled plastic container, the container having residual stresses resulting from its manufacture from a preform, which has been hot-filled and stoppered with liquid contents and then cooled once filled and stoppered, and being designed to undergo stress relief by a heat treatment, characterized in that it includes a stage prior to that of the heat treatment that consists in exerting mechanical force on the external surface of the thin wall of the container that is deformed by the hot filling to generate an interior pressure so as to compensate for at least the underpressure to which it is subjected and to restore its initial shape to it. An associated device for the implementation of the process is also described.

This invention relates to a process for treatment of a thin-walled plastic container as well as an associated device that is necessary for the implementation of said process.

A process for filling a thin-walled container is known by the European Patent Application No. 06 764 803.

This process proposes using the properties of the container and its ability to relieve stresses associated with its manufacture.

The process thus provides for using a thin-walled container that has residual stresses resulting from its manufacture.

Plastic containers are produced almost exclusively by manufacturing them by extrusion/blow-molding of a polyethylene terephthalate or PET preform.

As a result, during the hot deformation of this preform to make it achieve its final sizes and shapes, the final container stores stresses that are set in place by rapid cooling of said container, generally by blowing in air, at the extrusion/blow-molding outlet.

Even if a certain withdrawal of the container occurs when cooling, a withdrawal that is taken into consideration for the production of molds, the shape imparted by the mold to the container is very close to that of the mold, and the stresses are set in place at temperatures of use. These containers are provided and currently used to accommodate cold products such as mineral waters.

The working temperature during blow-molding extrusion is on the order of 100 to 120° C. Nevertheless, when hot filling is mentioned, the range of temperatures in question for the liquid varies from 60 to 95° C., or an adequate temperature for eliminating the pathogenic organisms but less than the manufacturing temperature of this container.

The stresses that are generated result from a longitudinal stretching associated with the action of a stretching rod and low-pressure inflation at the beginning, followed by high-pressure inflation of the container at the end of the cycle.

The thin-walled container that is thus used in this invention and is the subject of the patent application, presented in the preamble, is thus implemented for hot filling, which is not its primary purpose since it is commonly used today for mineral waters.

In contrast, the bottom of the container should be adapted to not be deformed, but numerous approaches known to one skilled in the art make it possible to make the bottom non-deformable at the temperatures and the pressure/underpressure values in question. Thus, a so-called petaloid bottom remains non-deformable under the conditions of use that will be presented in detail below.

Likewise, the container can undergo a particular heat treatment for making it a bit more resistant to high temperatures so as to accommodate a liquid at temperatures that are necessary for the destruction of pathogenic microorganisms.

The hot-filling process consists in sealing the container immediately after the filling, which ensures a sanitary treatment of the container, to cool the container and its contents. This filling and this cooling set in place a deformation of the container because the removal of the cooled liquid creates an underpressure inside the container, whose volume remains unchanged.

The container is then unsuitable for sale because of this phenomenon of collapse associated with the underpressure. The container is difficult to grip because it is slack, difficult to store because it has very poor compression strength, and its shape is completely unsightly and therefore not marketable.

The process according to the prior European application cited above then provides a stage for internal stress relief of the container, whereby this relief tends to return the container to the shape of the preform, from which it is obtained therefore to create a contraction and a corresponding reduction of the volume of the container.

This stress relief is obtained by a rise in temperature, beyond the hot-filling temperature of the single container.

This contraction of the volume of the container then creates an internal pressurization of the container, which has the direct consequence of restoring its first, uniform shape to said container and imparting rigidity to it before the filled and stoppered container is opened. This rigidity allows easy manipulation and makes it possible to make it withstand compression forces associated in particular with palletization and stacking of such containers.

It should be specified that in this process, the stress relief is achieved in the embodiment described by discriminatory heating, i.e., that the envelope is heated quickly so that the stresses are relieved without the liquid content itself being brought to temperature.

This invention proposes a suitable treatment process for generating stress relief in such a hot-filled and stoppered thin-walled container as well as the associated device.

It is actually suitable to provide a process and a device that ensure stress relief at hot-bottling speeds, 10,000 to 50,000 bottles/hour to provide an estimate, which leads to homogeneous stress relief and which is totally reliable and reproducible.

The difficulty is also to take into account economic conditions and therefore to produce stages for filling and stoppering containers with the best yield, primarily if steps are involved that require a supply of energy.

In addition, there is also the very important problem aimed at keeping intact the markings in relief of the container, such as names, logos . . . .

The process according to this invention is now described in detail as well as the associated device that makes it possible to implement said process.

This description is provided relative to the accompanying drawings in which the various figures show:

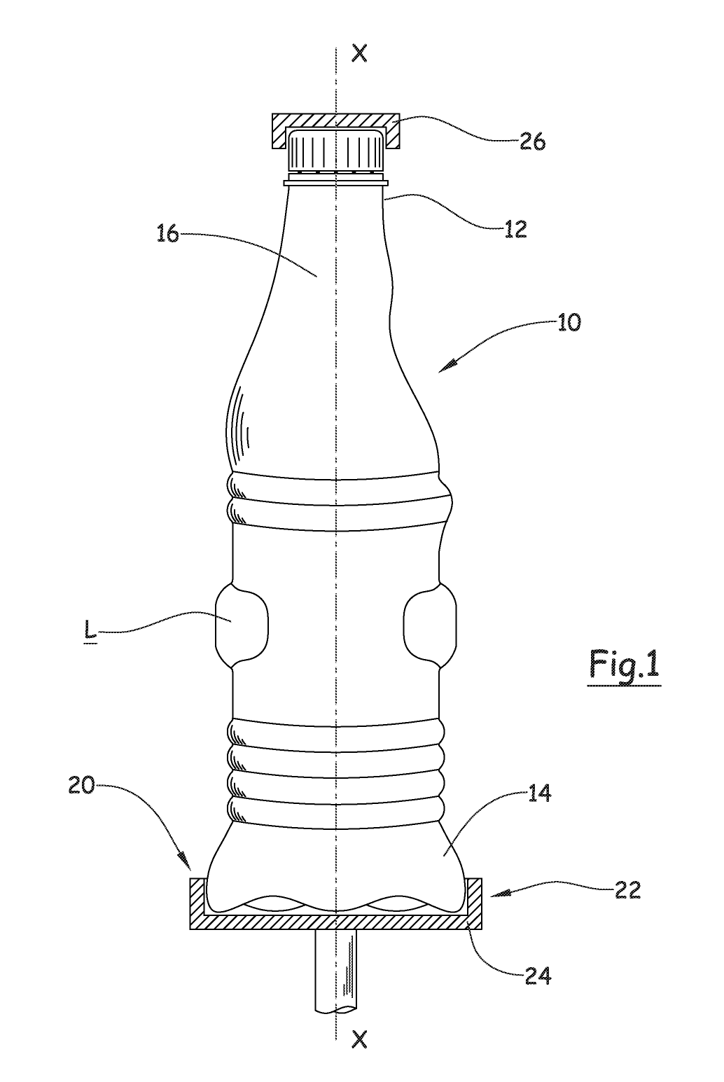

FIG. 1: A diagrammatic view of the container positioning station,

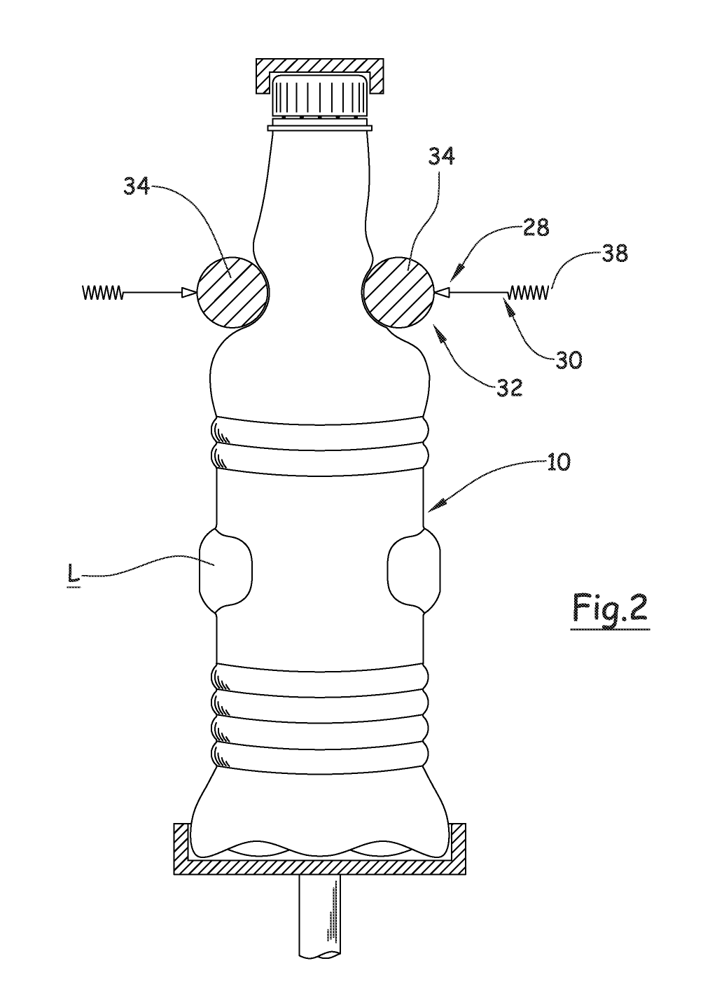

FIG. 2: A diagrammatic view of the mechanical pressurization station,

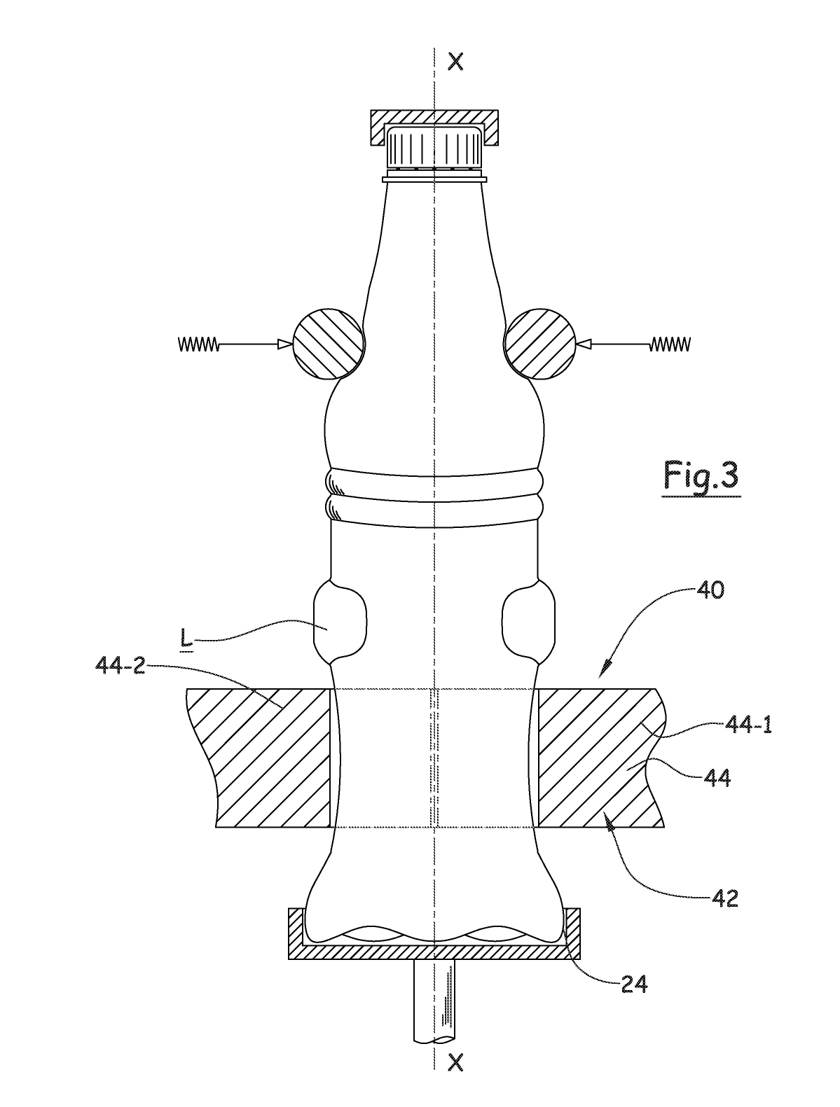

FIG. 3: A diagrammatic view of the heat treatment station,

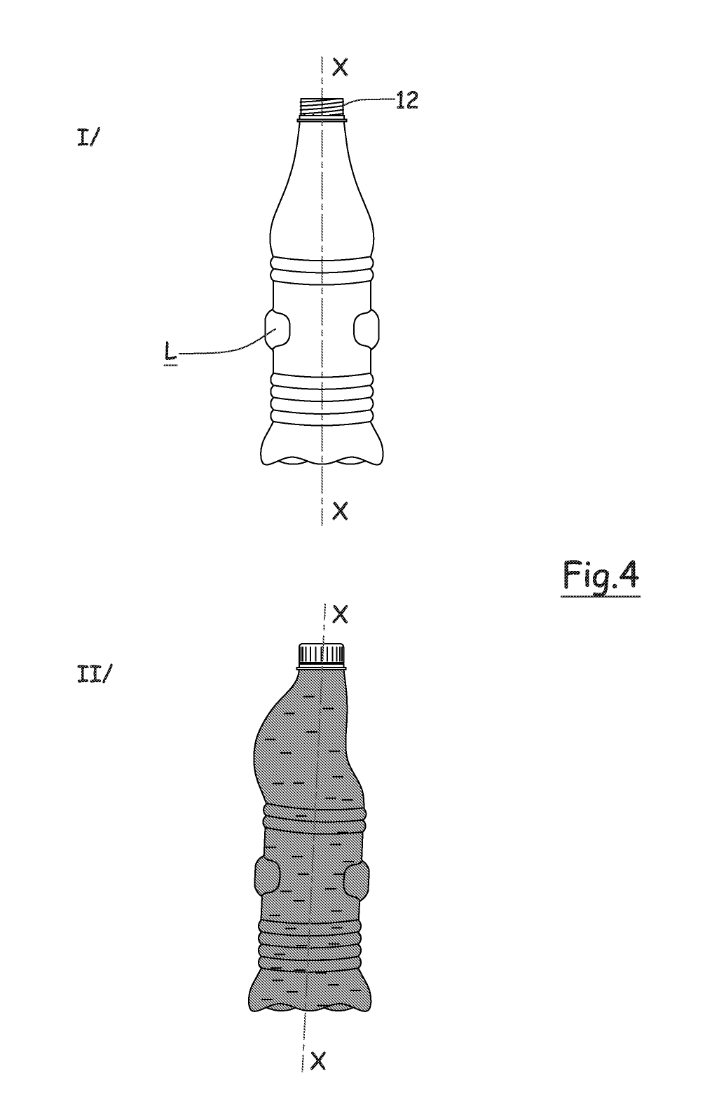

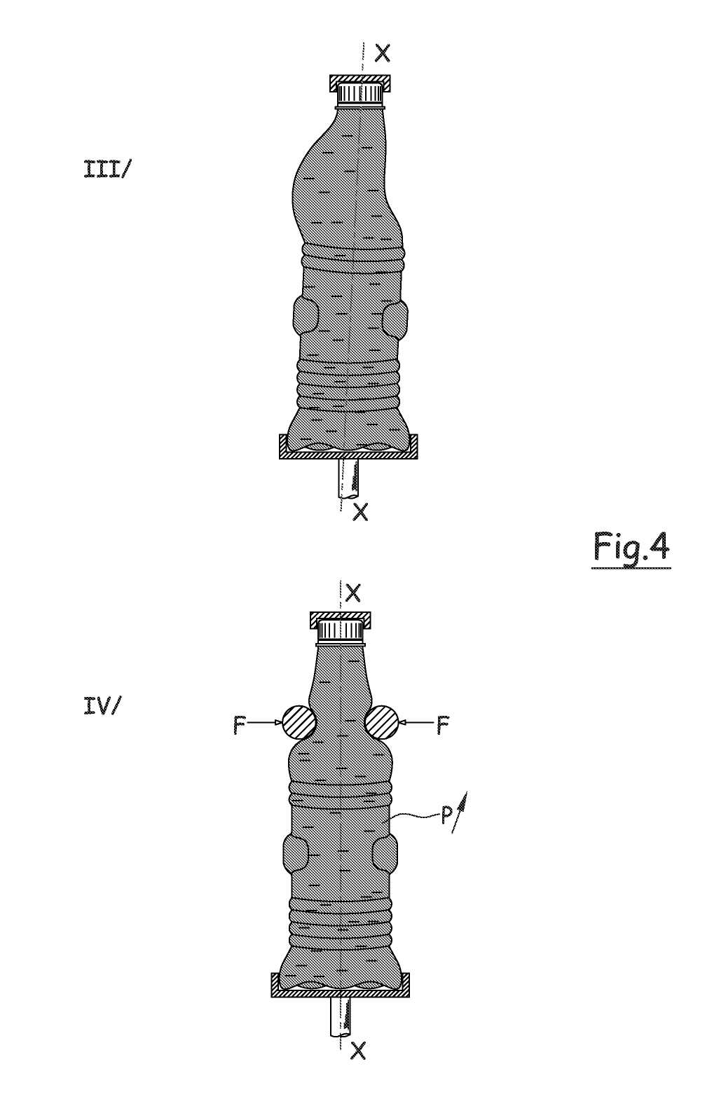

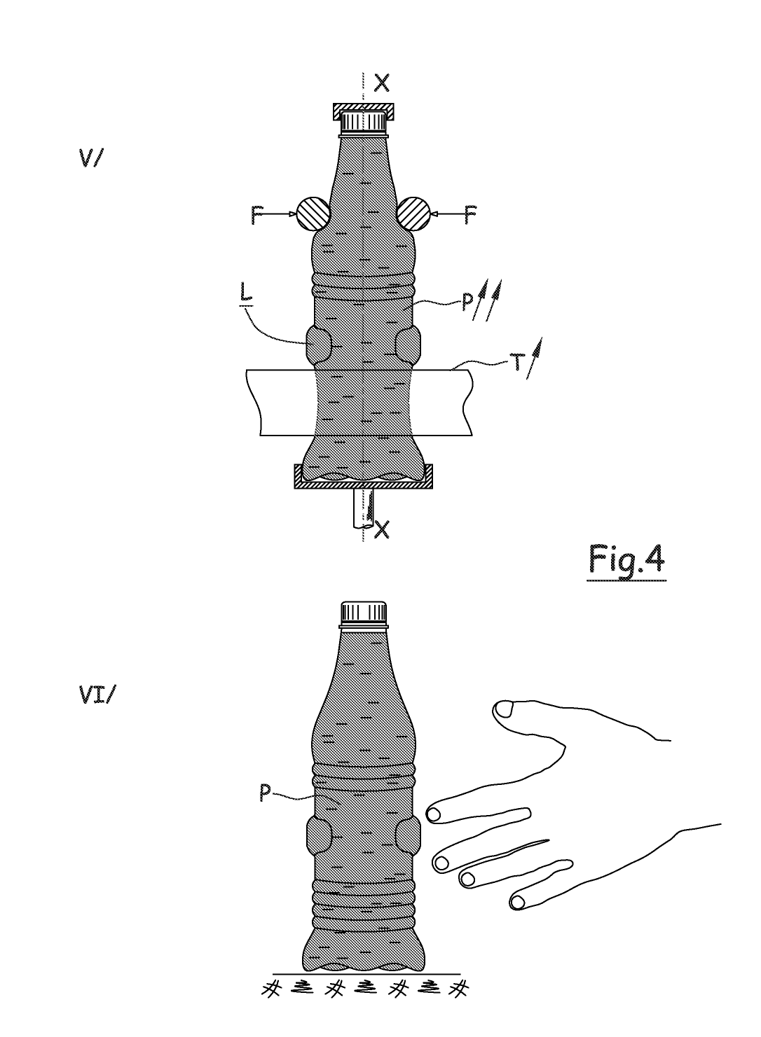

FIG. 4: A view of a block diagram of the implementation of the device according to the process of this invention with a parallel depiction of the container, and

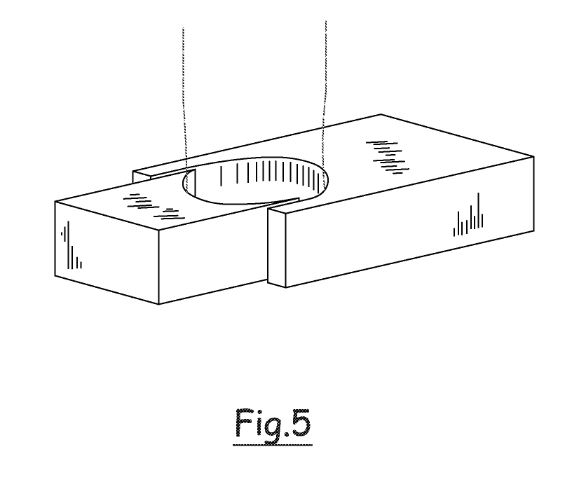

FIG. 5: A view of a variant embodiment of the half-shells.

The process consists in taking a thin-walled container 10, comprising a neck 12 and a bottom 14, for example a petaloid bottom that makes it possible to withstand deformations that are associated with pressures and underpressures implemented in the hot filling and stoppering process according to this invention, as a starting point.

This container is therefore filled in advance in a known way with a liquid 16 that has been previously heated to temperatures that are acceptable by the liquid and that make it possible to ensure the destruction of pathogenic microorganisms.

It is noted that during the filling, the interior of the body of the container and its stopper are also treated bacteriologically by the heat induced by the presence of the liquid.

The process consists in taking such a hot-filled container, sealed by a stopper 18, and cooled either naturally or in a forced manner by a cold-water shower, as a starting point, with the result being a container that is filled with a liquid that is free of pathogenic organisms, at ambient temperature, deformed by the underpressure generated by the contraction of the liquid, with an undeformed neck, a bottom that is also undeformed imparting its stability thereto.

Of course, the process applies to any container even if the bottom is deformable and the neck as well, and even if at the time of filling, the application is essentially on containers with non-deformable bottoms that can remain stable.

The process, known by the European Patent Application No. 06 764 803 in the name of the same applicant, consists in transferring calories directly to the container 10, more specifically to its thin wall, by greatly limiting the heating of the liquid because the cycle would be renewed and the cooling of the liquid would again create an underpressure.

For this purpose, the process according to this invention consists—prior to the heat treatment—in exerting a mechanical force on the external surface of the thin wall of the container that is deformed by the hot filling to generate an inside pressure so as to compensate for at least the underpressure to which it is subjected and to restore a stable geometric shape thereto.

According to another characteristic of said process, it is provided to transfer calories to the thin wall of said container, close to at least one zone of said container in such a way as to create stress relief of the thin wall in this zone and therefore pressurization of the interior of the container in its entirety.

The process provides for a positioning of the container by its bottom and its neck in such a way as to ensure said container is referenced along its longitudinal axis.

The process according to the invention also provides at least two stages for transfer of calories and a rotation of the container between these two transfers.

A device that is particularly suitable for the implementation of this process is now described in detail according to a particular, nonlimiting embodiment. The device is, in an integrated industrial way, preferably at the outlet of the chain for manufacture of the thin-walled containers by blow-molding extrusion and after the hot-filling and stoppering station, and even more particularly at the outlet of the station for cooling the containers that are thus hot-filled and stoppered.

The description is created relative to FIGS. 1 to 4.

The device comprises a station 20 for positioning containers 10 by the bottom 14 and the neck 12 topped by the stopper, shown in FIG. 1.

This positioning station 20 comprises a series of receiving units 22 of containers.

In this embodiment, each receiving unit 22 comprises a cup 24 for guiding and rotating in which rests the bottom 14 of the container and a guide head 26 that accommodates the neck 12.

The center of each cup 24 is aligned with the center of the head 26 so as to define a longitudinal X-X axis that is provided to be merged with the longitudinal axis of the container. This positioning station ensures a centering even if the container is itself deformed and affected by collapse phenomena.

The device comprises a station 28 for mechanical pressurization of the container, shown in FIG. 2.

In a preferred but nonlimiting manner, this pressurization station comprises mechanical means 30 for pressurizing the container. These mechanical pressurization means 30 comprise pressing devices 32 that consist of support pads 34 provided to flatten against the thin wall of the container 10 and means 36 for exerting force on these pads, such as springs 38.

According to one embodiment, these pads 34 are round bars, oriented along the axis of passage of the line, so as to press on the container without leaving a mark, as will be described below.

Such pads offer the advantage of making it possible to exert force on the wall even if the latter is deformed by the collapse phenomena.

The device is completed by a heat treatment station 40 shown in FIG. 3. This heat treatment station 40 comprises at least one hot wall 42, movable between two positions: said first opening position, away from the container 10, and the second so-called closing position, close to and/or in contact with the container. This wall is heated by any suitable means to temperatures that make possible the relief of stresses set in place in the container during manufacture.

This hot wall 42 covers at least one zone of the container.

According to a preferred embodiment of the device, the wall 42 is shaped.

Thus, the hot wall is a shell 44 with a shape that is mated to that of the zone in question of the container.

Even more preferably, the hot wall 42 comprises two half-shells 44-1 and 44-2 so as to be positioned around the container in its closing position.

It is noted that the two half-shells are centered relative to the longitudinal X-X axis, in the two opening and closing positions.

The two half-shells 44-1 and 44-2 rest against one another in the closed position so as to prevent any gap that might leave a mark on the container.

Reference is made to FIG. 4 for describing the implementation of the process through a block diagram.

In this FIG. 4, the empty container 10, removed from blow-molding extrusion, is shown in stage I. This container has the given shape that is shown in this figure, namely a general cylindrical shape with a body that comprises a logo L in relief in the low part of the body of the container with grooves and a top part that comprises grooves.

In FIG. 4, stage II, the container was hot-filled and stoppered. The container was cooled and is found to be slack because the liquid has contracted and its volume has decreased, producing an underpressure in the stoppered container that imparts this slack state to this container and to its contents.

This collapse phenomenon is accompanied by a deformation of the geometry of the container.

The thus collapsed container 10 is referenced on the positioning station, stage III, so that its axis of revolution is merged with the X-X positioning axis.

The bottom and the neck with its stopper are then centered.

Consequently, in stage IV, the container 10 is subjected to a mechanical pressurization at station 28; the support pads 34 are flattened against the thin wall of the container 10 by springs 38. The pressure that is exerted is therefore constant and continuous. This mechanical pressure of the pads, as shown in the depiction of the container, is specific, deforms the container facing the pads and leads to a reshaping of this container for all of the parts that are not subjected to the mechanical pressure.

Actually, the mechanical pressure is reflected by a local deformation of the container that produces an increase of the internal pressure of the container. The pressure that is exerted should be adequate for compensating for the underpressure associated with the contraction of the liquid after hot filling and cooling and for generating this internal pressure.

In stage V, the thus reshaped container is perfectly centered, and the outside contour is again in its initial profile. The container 10 can then be subjected to the transfer of calories to ensure stress relief.

The half-shells are in the open position and close around the container, facing the corresponding zone.

The stress relief is extremely fast, several seconds, and therefore occurs only in this zone.

The body of the container therefore assumes the shape of the shell in the zone in question while the rest of the container preserves its initial shape.

In this case, the zone in question is the low part of the container so as to keep intact the median part that bears the logo.

In this low part, the stress relief creates volumetric restraint and therefore pressurization of the interior of the container. This pressurization is adapted for, on the one hand, compensating for the mechanical pressure that is exerted and, on the other hand, preserving an internal pressure once the mechanical pressure is interrupted.

The residual mechanical pressure is to be adequate for providing rigidity to the container that is necessary for its gripping and its resistance to compression without thereby resulting in a container that is too rigid upon contact and in gripping, stage VI.

In addition, the internal pressure should be kept within a range such that the opening of the stopper does not cause too significant an escape of air that could induce flows of the contents.

It is noted that the necessary restraint is therefore very low in volumetric amplitude for reaching the desired result. Thus, the petaloid bottom is not subjected to pressures that can return it.

So as to provide an example, on a 500 ml bottle, the restraint is 8%, and the heating temperature of the half-shells is 200° C., to provide an estimate.

The transfer of calories is exerted directly on the wall and for a period that is so short that the heating of the contents is insignificant, on the order of several seconds, between 2 and 10 seconds to provide a range of values.

It is also possible to provide a fragmented transfer of calories in at least two fractions and a rotation of the container between the two transferred fractions, either within the same station or within the two successive stations. At the outlet of stage V, there is a thin-walled container of desired geometry and profile, filled with contents that have undergone heat treatment and where said container has been treated by heat; the parts of said container with stiffening patterns or grooves remain undeformed, with a general rigidity that is adequate for allowing the gripping thereof and their storage by stacking while ensuring uptake of the compressive forces.

The container can then be tagged and palletized.

The device was described in a preferred embodiment, but it is possible to provide variant embodiments without thereby exceeding the scope of this invention.

Thus, the application position of the mechanical pressure is selected based on possibilities namely based on the profile of the container, the zone that is to be treated and whose access by the hot wall is to remain open, in particular by the half-shells, knowing that this mechanical pressure can be exerted at any point, its result being distributed over the entire container. The means 36 for exerting force on the pads, in this case the springs 38, can be replaced by cylinders that make possible an adjustment of the exerted pressure.

Likewise, it is possible to provide half-shells that are inter-penetrating; this eliminates the attachment plane and prevents the rotation of the container and the fragmented transfer of calories. Such a depiction is indicated in symbolic form in FIG. 5.

The process that is implemented in particular through the proposed device makes it possible to open the stopper without thereby causing the overflow of the contents because the body has an adequate rigidity even after the stopper is opened. This stiffness is associated with the presence of grooves and other stiffeners associated with the container itself and associated with the very design of the container.

Such a process and such a device make possible a suitable and industrial implementation of the process that is the subject of the European Patent Application No. 06 764 803.

Since the container that is thus obtained and is filled with its contents has a thin wall, it does not require much raw material for its manufacture and a health guarantee, and ensures low recycling costs.

The process according to this invention induces greatly reduced additional energy expenses because the transfer is direct and fast without bringing the contents to temperature again when it was just cooled just after its filling, which would have made no sense industrially.

The modifications of a manufacturing line by providing a device such as the one described within the scope of this invention are relatively simple without significant additional expense while the gains achieved by using thin-walled containers are very significant.

1. Process for treatment of a thin-walled plastic container, said container having residual stresses resulting from its manufacture from a preform, which has been hot-filled and stoppered with liquid contents and then cooled once filled and stoppered, and being designed to undergo stress relief by a heat treatment, characterized in that it comprises a stage prior to that of the heat treatment that consists in exerting mechanical force on the external surface of the thin wall of the container that is deformed by the hot filling to generate an interior pressure so as to compensate for at least the underpressure to which it is subjected and to restore its initial shape to it.

2. Process for heat treatment of a thin-walled plastic container according to claim 1, wherein it consists in transferring calories to the thin wall of said container, close to at least one zone of said container so as to create stress relief of the thin wall in this zone and therefore pressurization of the interior of the container in its entirety.

3. Process for treatment of a thin-walled container according to claim 1, wherein it comprises a positioning of the container by its bottom and its neck so as to ensure said container is referenced along its longitudinal axis.

4. Process for treatment of a thin-walled container according to claim 1, wherein it comprises at least two stages for transfer of calories and a rotation of the container between these two transfers.

5. Process for treatment of a thin-walled container according to claim 1, wherein it makes use of a container with a non-deformable bottom and neck.

6. Device for heat treatment of a thin-walled container (10) that makes possible the implementation of the process according to claim 1, wherein it comprises:
A station (20) for positioning containers (10) by the bottom (14) and the neck (12),
A station (28) for mechanical pressurization of the container, and
A heat treatment station (40).

7. Device for heat treatment of a thin-walled container (10) according to claim 6, wherein the positioning station (20) comprises a receiving unit (22) that comprises a cup (24) for guiding and rotation in which rests the bottom (14) of the container and a guide head (26) that receives the neck (12), whereby the center of each cup (24) is aligned with the center of the head (26) so as to define a longitudinal X-X axis that is provided to be merged with the longitudinal axis of the container.

8. Device for heat treatment of a thin-walled container (10) according to claim 6, wherein the station (28) for mechanical pressurization of the container comprises mechanical means (30) for pressurization of the container, whereby these mechanical pressurization means (30) comprise pressing devices (32) composed of support pads (34) that are provided for flattening against the thin wall of the container (10) and means (36) for exerting force on these pads.

9. Device for heat treatment of a thin-walled container (10) according to claim 6, wherein the heat treatment station (40) comprises at least one hot wall (42) that can allow the relief of the stress set in place in the container during manufacture, movable between two positions: said first opening position, away from the container (10), and the second so-called closing position, close to and/or in contact with the container (10).

10. Device for heat treatment of a thin-walled container (10) according to claim 9, wherein this hot wall (42) covers at least one zone of the container.

11. Device for heat treatment of a thin-walled container (10) according to claim 10, wherein the wall (42) is a shell (44) with a shape that is mated to that of the zone in question of the container.

12. Device for heat treatment of a thin-walled container (10) according to claim 11, wherein the shell (44) comprises two half-shells (44-1, 44-2) so as to come to be positioned around the container in its closing position.

13. Device for heat treatment of a thin-walled container (10) according to claim 6, wherein the bottom and the neck of said container are non-deformable.

14. Device for heat treatment of a thin-walled container (10) according to claim 7, wherein the station (28) for mechanical pressurization of the container comprises mechanical means (30) for pressurization of the container, whereby these mechanical pressurization means (30) comprise pressing devices (32) composed of support pads (34) that are provided for flattening against the thin wall of the container (10) and means (36) for exerting force on these pads.

15. Device for heat treatment of a thin-walled container (10) according to claim 7, wherein the heat treatment station (40) comprises at least one hot wall (42) that can allow the relief of the stress set in place in the container during manufacture, movable between two positions: said first opening position, away from the container (10), and the second so-called closing position, close to and/or in contact with the container (10).

16. Device for heat treatment of a thin-walled container (10) according to claim 8, wherein the heat treatment station (40) comprises at least one hot wall (42) that can allow the relief of the stress set in place in the container during manufacture, movable between two positions: said first opening position, away from the container (10), and the second so-called closing position, close to and/or in contact with the container (10).

17. Process for treatment of a thin-walled container according to claim 2, wherein it comprises a positioning of the container by its bottom and its neck so as to ensure said container is referenced along its longitudinal axis.

18. Process for treatment of a thin-walled container according to claim 2, wherein it comprises at least two stages for transfer of calories and a rotation of the container between these two transfers.
